(19) United States
(12) Patent Application Publication
(10) Pub. No.: US 2025/0185820 A1
(43) Pub. Date: Jun. 12, 2025

(54) Adaptive Pressure-Redistributing Mattress System for Preventing and Treating Pressure Ulcers

(71) Applicant: Yoav Lichtenstein, Hod Hasharon (IL)

(72) Inventor: Yoav Lichtenstein, Hod Hasharon (IL)

(21) Appl. No.: 18/957,762

(22) Filed: Nov. 24, 2024

Related U.S. Application Data
(60) Provisional application No. 63/608,436, filed on Dec. 11, 2023.

(51) Int. Cl. A47C 27/08; A47C 27/10

(52) U.S. Cl. CPC A47C 27/083; A47C 27/10

(57) ABSTRACT

The present disclosure provides a mattress system comprising one or more inflatable air chambers, one or more movable units disposed within the air chambers, and a control unit. The movable units are equipped with sensors and actuators. The control unit is operatively connected to the air chambers and the movable units. The control unit is configured to independently inflate and deflate the air chambers to adjust pressure distribution across a surface supporting a human body, and to control movement and operation of the movable units based on data from the sensors. The system enables localized monitoring and treatment of the human body to prevent and treat pressure ulcers.

### CROSS-REFERENCE TO RELATED APPLICATIONS

This application claims priority to U.S. Application No. 63/608,436 titled Mattress for Pressure Ulcer Prevention and Treatment, filed Dec. 11, 2023, which is hereby incorporated by reference in its entirety.

### FIELD OF INVENTION

The present invention relates generally to a system and method for the prevention and treatment of pressure ulcers. The invention specifically relates to a mattress system that mitigates the risk of pressure ulcers in immobilized or bedridden individuals.

### BACKGROUND

Pressure ulcers, also known as decubitus ulcers or bedsores, are a prevalent and serious complication affecting individuals who are confined to a bed or immobile for extended periods. These localized areas of tissue damage typically develop over bony prominences such as the sacrum, heels, and hips, where prolonged pressure restricts blood flow to the skin and underlying tissues. The sustained compression of soft tissue between a bony prominence and an external surface leads to ischemia, which, if unrelieved, results in tissue necrosis and ulceration. The risk of developing pressure ulcers is particularly high among patients with limited mobility, sensory impairment, or compromised circulatory function.

Conventional pressure-relief mattresses have been widely employed in healthcare settings to mitigate the risk of pressure ulcer formation. These systems typically utilize air, foam, or gel-based technologies to redistribute pressure across the body surface. However, existing solutions often exhibit limitations in their ability to adapt to individual patient needs and provide comprehensive pressure management. While many current mattresses offer intermittent pressure relief through alternating pressure or low air loss features, they frequently lack the capability for continuous, real-time monitoring of both patient and mattress parameters. Furthermore, these systems are often limited in their ability to deliver targeted, localized treatment to specific areas at risk of ulceration.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a mattress system is provided. The mattress system includes one or more inflatable air chambers, and one or more movable units disposed therein. The air chambers are independently inflate and deflate to adjust pressure distribution across a surface supporting a human body.

According to other aspects of the present disclosure, the mattress system may include one or more of the following features. The movable units may be equipped with sensors and actuators to measure and treat physiological conditions of both the mattress and the human body based on real-time or historical data. The sensors may include at least one of a temperature sensor, a pressure sensor, a position sensor, or a radar-based sensor. The actuators may include at least one of a heating element, a cooling element, a massaging roller, or a mechanical arm configured to manipulate localized pressure on the human body. The movable units may be configured to traverse predefined tracks within the air chambers, wherein the tracks facilitate precise positioning of the movable units relative to the human body for localized monitoring and treatment.

The movable units may be operatively connected to a base station via a pulling mechanism, the pulling mechanism comprising a cable. In addition, the cable can be operative to supply electrical power, communication signals, and/or air for the operation or cooling/heating of the movable units, their cooling/heating element or its vicinity. The pulling mechanism may further comprise an encoder configured to monitor the position of the movable units within the air chambers, thereby enabling precise control over the movement and positioning of the movable units. The air chambers may be configured to operate in an overlapping manner when partially deflated, such that overlapping zones are created between adjacent chambers to provide enhanced monitoring and treatment coverage of the human body.

The movable units may be wireless and powered by onboard rechargeable batteries, the batteries being configured to recharge when the movable units are docked at a charging station located within or adjacent to the base unit. The wireless movable units may further comprise motorized wheels and a gimbal mechanism, the gimbal mechanism being operable to adjust the orientation of the sensors and actuators to optimize their positioning relative to the human body. The movable units may include hooks that engage corresponding hooks located in the air chambers, enabling localized pressure reduction by allowing the movable units to pull down the mattress around the engaging hooks. The hook mechanisms may be configured to generate localized mattress vibration when engaged, thereby stimulating tissue perfusion and enhancing circulation in targeted regions of the human body.

The movable units may be equipped with an array of sensors capable of detecting multiple physiological parameters, including but not limited to temperature, pressure, inclination, position, mattress deformation, and skin condition, the sensors being operable to communicate data to the control unit for processing and analysis. The sensors may further include an optical camera, ultrasound sensor, radar sensor, and/or a pressure wave sensor, each being configured to provide real-time data regarding the condition of the human body and the mattress. The actuators may be configured to provide therapeutic interventions, the interventions including localized heating, cooling, vibration, and mechanical massage, wherein the interventions are automatically triggered based on real-time sensor data and predefined treatment protocols.

The control unit may be operable to execute pre-programmed or dynamically generated treatment protocols, wherein the protocols are based on data collected from the sensors and are designed to prevent, mitigate, or treat pressure ulcers in specific regions of the human body. The control unit may further comprise a wireless communication module, the module being operable to communicate data to external devices or systems, including remote monitoring stations, to enable real-time observation and management of the patient's condition by healthcare professionals. The movable units may be further equipped with mechanical arms or massaging rollers configured to engage the surface of the mattress, the arms or rollers being operable to manipulate the mattress surface and apply targeted pressure to specific areas of the human body, thereby relieving pressure points and promoting blood circulation.

According to another aspect of the present disclosure, a method of preventing and treating pressure ulcers is provided. The method includes providing a mattress system having one or more inflatable air chambers and one or more movable units disposed within the chambers; continuously or intermittently inflating and deflating the air chambers to vary pressure distribution across the body; monitoring the physiological condition of the human body using sensors disposed within the movable units; adjusting the position of the movable units based on real-time sensor data; activating therapeutic actuators within the movable units to provide localized treatment, including heating, cooling, vibration, and mechanical massage; and dynamically adjusting the treatment protocol in response to real-time data from the sensors.

According to other aspects of the present disclosure, the method may include communicating data collected by the sensors to a remote monitoring station via a wireless communication module, enabling real-time monitoring of the patient's condition by healthcare professionals.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a schematic top view illustration of an embodiment of a mattress system constructed and operative in accordance with the invention;

FIG. 2 is a schematic partial top view illustration of the embodiment of FIG. 1;

FIG. 3 is a schematic top view illustration of a four-wheeled movable unit of the embodiment of FIG. 1;

FIG. 4 is a schematic side view illustration of the movable unit of FIG. 3;

FIG. 5 is a schematic top view illustration of optional sensors and actuators disposed in the movable unit of FIG. 3;

FIG. 6A is a schematic top view illustration of an optional wireless two-wheeled movable unit;

FIG. 6B is a schematic side view illustration of the movable unit of FIG. 6A;

FIGS. 7A and 7B, which are schematic illustrations of an optional inchworm movable unit featuring two inflation-deflation enabled torus balloons. FIG. 7A is a schematic top view illustration of a movable unit featuring two balloons and a piston;

FIG. 7B is a schematic front view illustration of the movable unit of FIG. 7A;

FIGS. 8A, 8B, and 8C, are schematic illustrations of several states of mattress chambers which are mounted on a base sheet of a mattress. FIG. 8A is a schematic illustration of two mattress chambers that are inflated, wherein a movable unit is positioned in one of the chambers;

FIG. 8B is a schematic illustration of the mattress chambers of FIG. 8A, wherein one of the chambers is deflated and the other chamber is inflated;

FIG. 8C is a schematic illustration of the mattress chambers of FIG. 8A, wherein one chamber is deflated and the other chamber is partially deflated to improve contact to the top of the mattress chambers and to create overlapping inspection/treating area;

FIG. 9A is a schematic illustration of two mattress chambers that are inflated, featuring hooks which are connected to the top and bottom of the mattress and which are connectable to corresponding hooks of a movable unit to allow local vibration or movement between the mattress top and bottom area, using actuators of the movable unit; and

FIG. 9B is a schematic illustration of the mattress chambers of FIG. 9A, wherein the movable unit is pulling together top and bottom mattress hooks.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

With respect to prior art, there remains a significant need for an advanced mattress system that can address the shortcomings of existing pressure ulcer prevention and treatment approaches. Such a system could incorporate continuous monitoring capabilities to assess both body and mattress parameters in real-time. Additionally, it could possess the ability to provide targeted, localized treatment to areas identified as high-risk or showing early signs of tissue damage. An effective solution would not only prevent the formation of pressure ulcers but also actively manage existing ulcers through adaptive pressure redistribution and therapeutic interventions. By integrating these features, an improved mattress system could significantly enhance the standard of care for immobilized individuals and reduce the incidence and severity of pressure ulcers in healthcare settings.

The present disclosure relates to an adaptive pressure-redistributing mattress system for preventing and treating pressure ulcers. The mattress system may comprise one or more inflatable air chambers and one or more movable units disposed within the air chambers. In some aspects, the air chambers may be independently inflated and deflated to adjust pressure distribution across a surface supporting a human body. The movable units may be equipped with sensors and actuators to measure and treat physiological conditions of both the mattress and the human body.

In certain implementations, the mattress system may include a control unit operatively connected to the air chambers and movable units. The control unit may be configured to control inflation and deflation of the air chambers, direct movement of the movable units, process data from the sensors, and activate the actuators based on the processed data. This adaptive control may allow for continuous monitoring and targeted interventions to prevent and treat pressure ulcers.

The sensors incorporated in the movable units may include temperature sensors, pressure sensors, position sensors, or radar-based sensors in some configurations. The actuators may comprise heating elements, cooling elements, massaging rollers, or mechanical arms configured to manipulate localized pressure on the human body. In some cases, the movable units may be configured to traverse predefined tracks within the air chambers, facilitating precise positioning for localized monitoring and treatment.

Some implementations of the mattress system may include a pulling mechanism operatively connecting the movable units to a base station. This pulling mechanism and/or another cable may supply electrical power, communication signals, or air for operation or cooling/heating of the movable units, their cooling/heating element or its vicinity. In certain aspects, the pulling mechanism may include an encoder to monitor the position of the movable units within the air chambers.

The air chambers of the mattress system may be designed to operate in an overlapping manner when partially deflated in some configurations. This feature may create overlapping zones between adjacent chambers, potentially providing enhanced monitoring and treatment coverage of the human body. In certain implementations, the movable units may be wireless and powered by onboard rechargeable batteries, with the capability to recharge when docked at a charging station.

Some configurations of the movable units may include hooks that engage corresponding mattress-hooks located in the air chambers. This arrangement may enable localized pressure reduction by allowing the movable units to pull down the mattress around the engaging hooks. The hook mechanisms may be configured to generate localized mattress vibration when engaged in some cases.

The adaptive pressure-redistributing mattress system described herein may provide comprehensive pressure management through continuous monitoring, targeted interventions, and dynamic pressure redistribution. These features may contribute to more effective prevention and treatment of pressure ulcers in individuals with limited mobility or those at risk of developing such ulcers.

The mattress system described herein may comprise one or more inflatable air chambers. In some aspects, these air chambers may be independently inflatable and deflatable to adjust pressure distribution across a surface supporting a human body. The mattress system may further include one or more movable units disposed within the air chambers. These movable units may be equipped with sensors and actuators to measure and treat physiological conditions of both the mattress and the human body.

In certain implementations, the mattress system may include a control unit operatively connected to the air chambers and movable units. The control unit may be configured to control inflation and deflation of the air chambers, direct movement of the movable units within the air chambers, process data from the sensors, and activate the actuators based on the processed data and/or historical. This configuration may allow for adaptive pressure redistribution and targeted interventions to prevent and treat pressure ulcers.

The sensors incorporated in the movable units may include, but are not limited to, temperature sensors, pressure sensors, position sensors, or radar-based sensors in some configurations. The actuators may comprise heating elements, cooling elements, massaging rollers, or mechanical arms configured to manipulate localized pressure on the human body. In some cases, the movable units may be configured to traverse within the air chambers, facilitating precise positioning for localized monitoring and treatment.

The mattress system may be provided with the inflatable air chambers and movable units pre-installed within the chambers. Alternatively, in some aspects, the movable units may be insertable into the air chambers after the mattress system has been assembled. This modular approach may allow for customization and easy maintenance of the system.

The mattress system may include one or more inflatable air chambers. In some aspects, the mattress system comprises at least two independently inflatable air chambers. The control unit may be configured to independently inflate and deflate each air chamber to adjust pressure distribution across the surface supporting a human body. This independent control of inflation and deflation allows for customized pressure management in different areas of the mattress.

In certain implementations, the air chambers may be configured to operate in an overlapping manner when partially deflated. This overlapping operation may create overlapping zones between adjacent chambers. The creation of overlapping zones may provide enhanced monitoring and treatment coverage of the human body. For example, in some cases, when one chamber is partially deflated, an adjacent chamber may extend its coverage area to overlap with the partially deflated chamber. This overlapping configuration may allow for more continuous pressure redistribution and reduce the risk of pressure points forming between chamber boundaries.

The ability to independently control the inflation and deflation of multiple air chambers may allow for dynamic pressure redistribution. In some aspects, the control unit may adjust the inflation levels of different chambers based on sensor data from the movable units or other inputs. This dynamic adjustment may help to periodically redistribute pressure across different areas of the body, potentially reducing the risk of pressure ulcer formation.

The overlapping operation of the air chambers may also facilitate smoother transitions in pressure distribution across the mattress surface. In some implementations, the control unit may gradually adjust the inflation levels of adjacent chambers to create a more gradual pressure gradient, rather than abrupt changes at chamber boundaries. This gradual transition may enhance comfort for the user while maintaining effective pressure redistribution.

The mattress system may include one or more movable units disposed within the air chambers. In some aspects, these movable units may be configured to traverse predefined tracks within the air chambers. The tracks may facilitate precise positioning of the movable units relative to the human body for localized monitoring and treatment. This configuration may allow the movable units to access specific areas of the body that require attention or intervention.

In certain implementations, the movable units may include an inchworm-style design. This design may comprise two inflatable torus balloons and a piston. The torus balloons may be capable of inflation and deflation, while the piston may enable increasing and decreasing the distance between the two sections of the movable unit. This mechanism may allow the movable unit to advance forward or backward within the air chamber in synchronization with the inflation and deflation of the torus balloons.

The movable units may include a computational unit and a battery in some cases. The computational unit may process data from sensors and control the operation of actuators. The battery may provide power to the various components of the movable unit, allowing for autonomous operation within the air chambers.

In some implementations, the movable units may be equipped with various sensors and actuators. The sensors may include, but are not limited to, temperature sensors, pressure sensors, position sensors, or radar-based sensors. These sensors may allow the movable units to gather data about the physiological conditions of both the mattress and the human body. The actuators may include heating elements, cooling elements, massaging rollers, or mechanical arms. These actuators may be configured to manipulate localized pressure on the human body or provide therapeutic interventions based on the sensor data.

The ability of the movable units to traverse within the air chambers may allow for dynamic and targeted monitoring and treatment. In some aspects, the control unit may direct the movement of the movable units based on the data collected by the sensors. This may enable the system to focus on areas of the body that are at higher risk of developing pressure ulcers or require more frequent monitoring.

The movable units may be equipped with various types of sensors to monitor physiological conditions of the body and the mattress environment. In some aspects, these sensors may include at least one of a temperature sensor, a pressure sensor, a position sensor, or a radar-based sensor. The sensors may be configured to collect data continuously or at predetermined intervals, providing real-time information about the patient's condition and the mattress surface.

Temperature sensors may be used to monitor the body temperature of the patient as well as the temperature of the mattress surface. In some cases, these sensors may detect localized temperature changes that could indicate areas of increased pressure or potential tissue damage. Pressure sensors may measure the distribution of pressure across the mattress surface and identify areas where excessive pressure may be applied to the patient's body. This information may be used to adjust the inflation levels of the air chambers or activate localized pressure relief mechanisms.

Position sensors may track the patient's body position and movements on the mattress. In some implementations, these sensors may detect when a patient has remained in one position for an extended period, potentially increasing the risk of pressure ulcer formation. Radar-based sensors may provide non-contact monitoring of vital signs such as heart rate and respiratory rate. These sensors may operate through the mattress material, allowing for continuous monitoring without direct contact with the patient's skin.

In certain aspects, the movable units may also incorporate additional sensing technologies. For example, a camera may be included to capture visual information about the patient's skin condition or the mattress surface. An ultrasound array may be used to assess tissue health and detect early signs of pressure ulcer formation beneath the skin surface. The radar unit may provide more detailed information about patient movement and positioning within the mattress system.

The data collected by these various sensors may be processed by the control unit to create a comprehensive picture of the patient's physiological condition and the mattress environment. This information may be used to dynamically adjust the mattress system's settings and activate appropriate interventions to prevent or treat pressure ulcers. In some cases, the sensor data may also be transmitted to healthcare providers for remote monitoring and analysis.

The movable units may be equipped with various types of actuators to provide localized treatment and pressure manipulation. In some aspects, these actuators may include at least one of a heating element, a cooling element, a massaging roller, or a mechanical arm. The actuators may be configured to manipulate localized pressure on the human body and deliver therapeutic interventions based on sensor data and control signals from the control unit.

Heating elements may be incorporated into the movable units to provide localized heat therapy. In some cases, these heating elements may be used to increase blood flow to specific areas of the body, potentially promoting tissue healing and reducing the risk of pressure ulcer formation. Cooling elements may also be included in the movable units. These cooling elements may be activated to reduce inflammation or provide comfort in areas experiencing excessive heat or pressure.

Massaging rollers may be integrated into the movable units to provide mechanical stimulation to the skin and underlying tissues. In some implementations, these rollers may be configured to move in both vertical and horizontal directions relative to the human body plane. The movement of the massaging rollers may help to improve circulation and reduce the risk of pressure ulcer formation by periodically relieving pressure on specific areas of the body.

Mechanical arms may be incorporated into the movable units to manipulate localized pressure on the human body. In some aspects, these mechanical arms may be capable of applying varying degrees of pressure to specific areas of the body. The mechanical arms may be used to gently lift or support parts of the body, temporarily relieving pressure on high-risk areas.

The control unit may activate these actuators within the movable units to provide localized treatment based on sensor data and predefined treatment protocols. In some cases, the activation of specific actuators may be triggered automatically in response to detected changes in pressure, temperature, or other physiological parameters. For example, if a pressure sensor detects an area of sustained high pressure, the control unit may activate a mechanical arm to temporarily lift that area of the body, or engage a massaging roller to stimulate circulation in the affected region.

The combination of different types of actuators in the movable units may allow for a versatile approach to pressure ulcer prevention and treatment. In some implementations, multiple actuators may be used in conjunction to provide comprehensive care. For instance, a heating element may be activated to increase blood flow to an area, followed by the use of a massaging roller to further stimulate circulation and tissue health.

The mattress system may include a control unit operatively connected to the air chambers and movable units. In some aspects, the control unit may be configured to control inflation and deflation of the air chambers, direct movement of the movable units within the air chambers, process data from the sensors, and activate the actuators based on the processed data. This configuration may allow for adaptive pressure redistribution and targeted interventions to prevent and treat pressure ulcers.

In certain implementations, the control unit may be programmed to execute predefined treatment protocols based on sensor data and patient information. These protocols may include specific sequences of air chamber inflation/deflation, movable unit positioning, and actuator activation tailored to different patient conditions or risk levels. The control unit may also be capable of dynamically generating and modifying treatment protocols in real-time based on ongoing sensor measurements and patient responses.

The control unit may continuously analyze data from the various sensors to make decisions about movable unit positioning and actuator activation. For example, if pressure sensors detect an area of sustained high pressure, the control unit may direct a nearby movable unit to that location and activate its massage rollers or mechanical arms to relieve pressure and stimulate circulation. Similarly, if temperature sensors indicate a localized increase in skin temperature, the control unit may activate cooling elements in that area to reduce inflammation risk.

In some cases, the mattress system may include a wired or wireless communication module integrated with or connected to the control unit. This module may enable the system to transmit data to external devices or systems, such as hospital monitoring stations or healthcare provider tablets. The communication capability may allow for real-time remote monitoring of patient status, system performance, and treatment progress. Healthcare providers may be able to receive alerts, view trends, and even remotely adjust treatment parameters through this interface.

The control unit may also be designed to adapt its operation based on input from healthcare providers or changes in patient condition. In some implementations, the control unit may incorporate machine learning algorithms to optimize treatment protocols over time based on observed outcomes and patient-specific factors. This adaptive functionality may allow the mattress system to provide increasingly personalized and effective pressure ulcer prevention and treatment.

In some aspects, the movable units may be configured to traverse predefined tracks within the air chambers. These tracks may facilitate precise positioning of the movable units relative to the human body for localized monitoring and treatment. The predefined tracks may be designed to allow the movable units to access specific areas of the body that require attention or intervention. In certain implementations, the tracks may be formed as grooves or channels within the air chamber walls or floor, guiding the movement of the movable units along predetermined paths.

The movable units may be equipped with mechanisms that engage with these tracks, such as wheels, rollers, or sliding components. In some cases, the tracks may incorporate a rail system that the movable units can attach to and move along. This configuration may provide stability and ensure accurate positioning of the movable units within the air chambers.

The control unit may direct the movement of the movable units along these predefined tracks based on sensor data or predetermined protocols. For example, if a particular area of the body is identified as requiring more frequent monitoring or treatment, the control unit may instruct a movable unit to traverse the tracks to position itself near that area. In some implementations, multiple movable units may be coordinated to move along different tracks simultaneously, allowing for comprehensive coverage of the mattress surface.

The predefined tracks may be arranged in various patterns within the air chambers. In some aspects, the tracks may form a grid-like pattern, allowing the movable units to access any point on the mattress surface. Alternatively, the tracks may be designed with specific routes that correspond to common pressure points or areas of concern on the human body. This targeted approach may enable efficient use of the movable units for pressure ulcer prevention and treatment.

In certain cases, the predefined tracks may include branching points or intersections, allowing the movable units to change direction or switch between different paths. This flexibility may enhance the system's ability to adapt to changing patient needs or to navigate around obstacles. The control unit may use sensor data and position feedback from the movable units to determine optimal routes along the tracks for specific monitoring or treatment tasks.

In some aspects, the mattress system may include a mechanism operatively connecting the movable units to a base station. This mechanism may comprise a cable that supplies at least one of electrical power, communication signals, or air for operation or cooling/heating of the movable units, their cooling/heating element or its vicinity, and which can also serve as a pulling mechanism. The cable may be designed to provide multiple functionalities, allowing for efficient transfer of resources and data between the base station and the movable units.

The mechanism may further comprise an encoder configured to monitor the position of the movable units within the air chambers. This encoder may provide precise location information, enabling accurate tracking and control of the movable units as they traverse the air chambers. In some cases, the encoder may utilize optical, magnetic, or mechanical sensing techniques to determine the position of the movable units relative to fixed reference points within the air chambers.

The base station may include an air manifold with pumps, valves, and sensors. This air manifold may be responsible for controlling the inflation and deflation of the air chambers, as well as supplying compressed air to the movable units when needed. The pumps within the air manifold may generate the necessary air pressure, while the valves may regulate the airflow to different components of the mattress system. Sensors in the air manifold may monitor air pressure, flow rates, and other relevant parameters to ensure optimal performance of the system.

In some implementations, the mechanism is a pulling mechanism which is also used to supply electrical power to the movable units. This power supply may enable the operation of various components within the movable units, such as sensors, actuators, and computational units. The cable may be designed to handle the required voltage and current levels safely and efficiently.

Communication signals may also be transmitted through the pulling mechanism in certain aspects. These signals may facilitate bidirectional data exchange between the movable units and the base station or control unit. The communication capabilities may allow for real-time transmission of sensor data, control commands, and system status information.

In some cases, the pulling mechanism may be utilized to supply compressed air to the movable units. This air supply may be used for various purposes, such as cooling internal components, operating pneumatic actuators, or inflating certain elements of the movable units. The air supply through the cable may provide a reliable and continuous source of compressed air without the need for onboard air compressors in the movable units.

The encoder associated with the pulling mechanism may play a crucial role in monitoring the positions of the movable units within the air chambers. By providing accurate position data, the encoder may enable precise control over the movement and positioning of the movable units. This capability may be particularly useful for targeted monitoring and treatment of specific areas of the patient's body.

In some aspects, the pulling mechanism may also serve as a means of retracting the movable units towards the base station when needed. This retraction capability may facilitate maintenance, charging, or reconfiguration of the movable units without the need for manual intervention within the air chambers.

The integration of power supply, communication, air delivery, and position encoding functionalities into a single pulling mechanism may offer several advantages. It may reduce the complexity of connections between the movable units and the base station, minimize the risk of tangled cables or tubes, and provide a streamlined solution for resource and data transfer within the mattress system.

In some aspects, the movable units may be wireless and powered by onboard rechargeable batteries. These batteries may be configured to recharge when the movable units are docked at a charging station. The charging station may be located within or adjacent to the base unit of the mattress system. This wireless configuration may allow for greater flexibility in the movement and positioning of the movable units within the air chambers.

The wireless movable units may further comprise motorized wheels in certain implementations. These motorized wheels may enable the movable units to traverse within the air chambers independently, without the need for a physical connection to a base station. The motorized wheels may be controlled by the onboard computational unit of the movable unit or by signals received from the central control unit of the mattress system.

In some cases, the wireless movable units may include a gimbal mechanism. This gimbal mechanism may be operable to adjust the orientation of the sensors and actuators mounted on the movable unit. The ability to adjust orientation may allow for optimization of the positioning of sensors and actuators relative to the human body. For example, the gimbal mechanism may enable tilting or rotating of sensor arrays to maintain optimal contact with the mattress surface or the patient's body as the movable unit changes position.

The gimbal mechanism may comprise two or more rotatable axes in some implementations. These axes may allow for adjustment in multiple planes, such as pitch and yaw. In certain aspects, the gimbal mechanism may provide a range of motion of +180 degrees along one or more axes. This range of motion may allow the sensors and actuators to be oriented in virtually any direction relative to the mattress surface or the patient's body.

The use of wireless, battery-powered movable units with motorized wheels and gimbal mechanisms may offer several advantages in the context of pressure ulcer prevention and treatment. The wireless nature of these units may reduce the complexity of the overall system by eliminating the need for physical connections between the movable units and the base station. This may result in a more flexible and adaptable system that can easily accommodate different mattress configurations or patient needs.

The rechargeable battery system may allow for extended operation of the movable units without the need for constant external power. In some cases, the control unit may monitor the battery levels of the movable units and direct them to return to the charging station when their power levels are low. This automated charging process may help ensure continuous operation of the mattress system without manual intervention.

The combination of motorized wheels and a gimbal mechanism may enable precise positioning and orientation of the sensors and actuators. In some implementations, the control unit may use data from the movable unit's sensors to determine the optimal orientation for monitoring or treatment. The gimbal mechanism may then adjust the sensor and actuator orientation accordingly, potentially improving the accuracy of measurements and the effectiveness of treatments.

In certain aspects, the wireless capabilities of the movable units may also facilitate easier maintenance and upgrades of the mattress system. For example, individual movable units may be removed from the system for servicing or replacement without disrupting the operation of other components. Similarly, new movable units with updated sensors or actuators may be easily integrated into an existing system, potentially extending the useful life of the overall mattress system.

In some aspects, the movable units may include hooks that engage corresponding mattress hooks located in the air chambers. These hooks may be designed to enable localized pressure reduction and manipulation of the mattress surface. The hooks on the movable units may be positioned on the upper and lower sections of the unit, allowing for engagement with mattress hooks on both the top and bottom surfaces of the air chambers.

The engaging hooks may allow the movable units to pull down the mattress around specific areas. In some cases, this pulling action may create localized depressions or contours in the mattress surface, potentially redistributing pressure away from high-risk areas of the patient's body. The control unit may direct the movable units to engage these hooks based on sensor data indicating areas of sustained pressure or other physiological parameters that suggest an increased risk of pressure ulcer formation.

The hook mechanisms may also be utilized to generate local mattress vibration in certain implementations. By rapidly engaging and disengaging the hooks or applying alternating pulling forces, the movable units may create controlled vibrations in specific areas of the mattress surface. These vibrations may help stimulate blood flow, promote tissue oxygenation, and potentially reduce the risk of pressure ulcer formation in targeted areas.

In some aspects, the intensity and frequency of the vibrations generated by the hook mechanisms may be adjustable. The control unit may modulate these parameters based on factors such as the patient's condition, the duration of sustained pressure in a particular area, or predefined treatment protocols. The ability to generate localized vibrations may provide an additional therapeutic modality for pressure ulcer prevention and treatment without the need for separate vibration motors or actuators.

The hook mechanisms may be designed with safety features to prevent unintended engagement or disengagement. In some cases, the hooks may incorporate locking mechanisms or sensors that provide feedback to the control unit about the engagement status. This feedback may help ensure that the pulling and vibration actions are applied safely and effectively.

In certain implementations, the arrangement of hooks in the air chambers may be customizable or adjustable. This flexibility may allow for optimization of the hook placement based on factors such as the patient's size, weight distribution, or specific areas of concern. The customizable hook arrangement may enhance the system's ability to provide targeted pressure relief and vibration therapy across different patient populations.

The mattress system may be used to implement a method of preventing and treating pressure ulcers. In some aspects, this method may involve continuously or intermittently inflating and deflating the air chambers to vary pressure distribution across a body supported by the mattress surface. The control unit may direct this inflation and deflation process according to predetermined protocols or based on real-time sensor data.

In certain implementations, the method may include monitoring physiological conditions of the body using sensors disposed within the movable units. These sensors may collect data on parameters such as temperature, pressure, position, or other relevant physiological indicators. The control unit may process this sensor data to assess the risk of pressure ulcer formation in different areas of the body.

Based on the processed sensor data, the method may involve adjusting the positions of the movable units within the air chambers. In some cases, the control unit may direct a movable unit to traverse to a specific location where increased monitoring or intervention is required. This positioning may allow for more focused data collection or targeted treatment delivery.

The method may further include activating actuators within the movable units to provide localized treatment. In some aspects, this activation may be triggered automatically based on the sensor data and predefined treatment protocols. For example, if sustained high pressure is detected in a particular area, the control unit may activate massage rollers or mechanical arms to relieve pressure and stimulate circulation in that region.

In certain implementations, the method may involve dynamically adjusting the inflation levels of different air chambers based on the monitored physiological conditions and movable unit positions. This dynamic adjustment may help to periodically redistribute pressure across different areas of the body, potentially reducing the risk of pressure ulcer formation.

The method may also include generating localized mattress vibrations using the hook mechanisms of the movable units in some cases. These vibrations may be applied intermittently or continuously to specific areas identified as high-risk for pressure ulcer development, potentially promoting blood flow and tissue oxygenation.

In some aspects, the method may incorporate wired or wireless communication to transmit collected data to external monitoring systems or healthcare providers. This may allow for remote assessment of the patient's condition and potential adjustments to the treatment protocols.

The method may be implemented continuously over extended periods, with the mattress system adapting its operations based on changing patient conditions and accumulated data. In some cases, the control unit may employ machine learning algorithms to optimize the prevention and treatment strategies over time, potentially improving the effectiveness of pressure ulcer management for individual patients.

The control unit may process sensor data from the movable units to dynamically adjust their positions and activate appropriate treatments. In some aspects, the control unit may analyze data from multiple sensor types to create a comprehensive assessment of the patient's condition and risk factors for pressure ulcer development. This analysis may involve comparing current sensor readings to historical data or predefined thresholds.

Based on the processed sensor data, the control unit may determine optimal positions for the movable units within the air chambers. In some cases, the control unit may direct a movable unit to traverse to a specific location where increased monitoring or intervention is required. For example, if pressure sensors detect an area of sustained high pressure, the control unit may position a movable unit near that area for more focused data collection or treatment delivery.

The control unit may also use the processed sensor data to activate appropriate actuators within the movable units. In some implementations, this activation may be triggered automatically based on predefined treatment protocols. For instance, if temperature sensors indicate a localized increase in skin temperature, the control unit may activate cooling elements in the nearby movable unit to reduce inflammation risk.

In certain aspects, the control unit may employ adaptive algorithms to optimize treatment strategies over time. These algorithms may analyze the effectiveness of previous interventions and adjust future actions accordingly. For example, if a particular combination of massage and pressure relief has been effective for a patient in the past, the control unit may prioritize similar interventions in future situations.

The control unit may also coordinate the actions of multiple movable units to provide comprehensive care. In some cases, one movable unit may be positioned to monitor an area while another is simultaneously activated to deliver treatment. This coordinated approach may allow for continuous assessment of treatment efficacy and real-time adjustments as needed.

In some implementations, the control unit may integrate data from external sources, such as patient medical records or input from healthcare providers, to further refine its decision-making process. This integration may allow for more personalized and context-aware interventions tailored to each patient's specific needs and risk factors.

In some implementations, the mattress system may include wired or wireless communication capabilities to enable remote monitoring and data transmission to healthcare professionals. The control unit may be equipped with a wireless communication module that allows for secure transmission of data collected by the sensors and processed by the control unit. This functionality may enable real-time monitoring of patient status, system performance, and treatment progress without the need for physical presence at the bedside.

The wireless communication module may utilize various protocols such as Wi-Fi, Bluetooth, cellular networks, or other proprietary wireless technologies to establish connections with external devices or systems. In some cases, the mattress system may be configured to connect to a hospital's existing wireless network infrastructure, allowing for seamless integration with other medical monitoring systems.

Healthcare professionals may access the transmitted data through dedicated software applications on computers, tablets, or smartphones. These applications may provide a user-friendly interface for viewing real-time sensor readings, historical trends, and system status information. In some aspects, the software may include customizable alerts that notify healthcare providers when certain parameters exceed predefined thresholds, potentially indicating an increased risk of pressure ulcer formation or the need for intervention.

The communication capabilities may also allow for remote adjustment of treatment parameters by authorized healthcare professionals. In some implementations, doctors or nurses may be able to modify inflation patterns, adjust sensor sensitivity, or update treatment protocols remotely based on the patient's evolving condition. This remote access may enable more responsive and personalized care, particularly in situations where frequent in-person assessments are challenging or impractical.

Data transmitted may be encrypted to ensure patient privacy and comply with relevant healthcare data protection regulations. The system may incorporate robust security measures to prevent unauthorized access to sensitive patient information. In some cases, the communication module may support multiple levels of access, allowing different healthcare team members to view or modify specific aspects of the system based on their roles and responsibilities.

The communication capabilities may also facilitate the aggregation and analysis of data from multiple mattress systems. In some implementations, anonymized data from numerous patients may be collected and analyzed to identify trends, optimize treatment protocols, and contribute to broader research efforts in pressure ulcer prevention and management. This data-driven approach may lead to continuous improvements in the system's effectiveness and the overall standard of care for patients at risk of pressure ulcers.

In certain aspects, the communication module may support two-way communication, allowing for remote software updates and system diagnostics. This capability may enable the mattress system to receive periodic updates to its firmware or treatment algorithms, ensuring that it remains up-to-date with the latest advancements in pressure ulcer prevention and treatment strategies. Remote diagnostics may allow technical support teams to troubleshoot issues and provide assistance without the need for on-site visits, potentially reducing system downtime and improving overall reliability.

The communication features may be designed with power efficiency in mind to minimize their impact on the overall power consumption of the mattress system. In some implementations, the communication module may utilize low-power transmission modes or adaptive power management techniques to optimize battery life in wireless movable units or conserve energy in mains-powered components.

In accordance with an embodiments of the invention, air chambers are connected to a base unit that comprises: (a) an air manifold that includes pumps, valves, and sensors; (b) a control unit that includes electrical and computational subunits connected via wired and wireless connections to all mattress subcomponents; and (c) an optional pulling cable mechanism and cable harness connected to each movable unit, which may comprise power supply and communication wires and air pipes. The pulling mechanism may include an encoder to further support movable unit position identification.

The movable unit can be built in various versions to accommodate different requirements. For example, a wireless movable unit with two motorized wheels and an actuator-sensor unit is mounted on a motorized gimbal consisting of two rotatable axes with a ±180-degree span-flip axis and side-to-side axis. Another example is an inchworm movable unit with two inflation-deflation enabled torus balloons and a piston that enables increasing and decreasing the distance between the two sections.

The movable unit may include upper hooks on its top section and bottom section, with corresponding “engaging hooks” scattered on the chamber bottom close to the base sheet and opposite ones on the chamber ceiling close to the human body. This configuration enables the movable unit to pull down the mattress around the engaging hooks using the movable unit actuators with the upper and bottom hooks, thereby relieving local pressure applied on the human body. The pulling force can be intermittent, generating local mattress vibration. A pulling action where only the upper ceiling engaging hooks are pulled enables improved proximity to the sensor/actuator unit mounted on the movable unit body or gimbals.

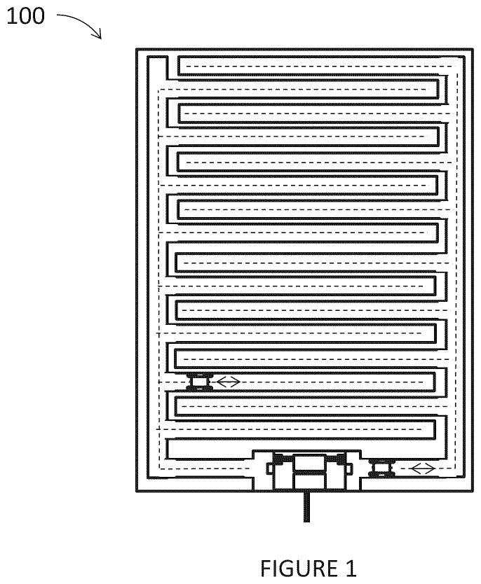

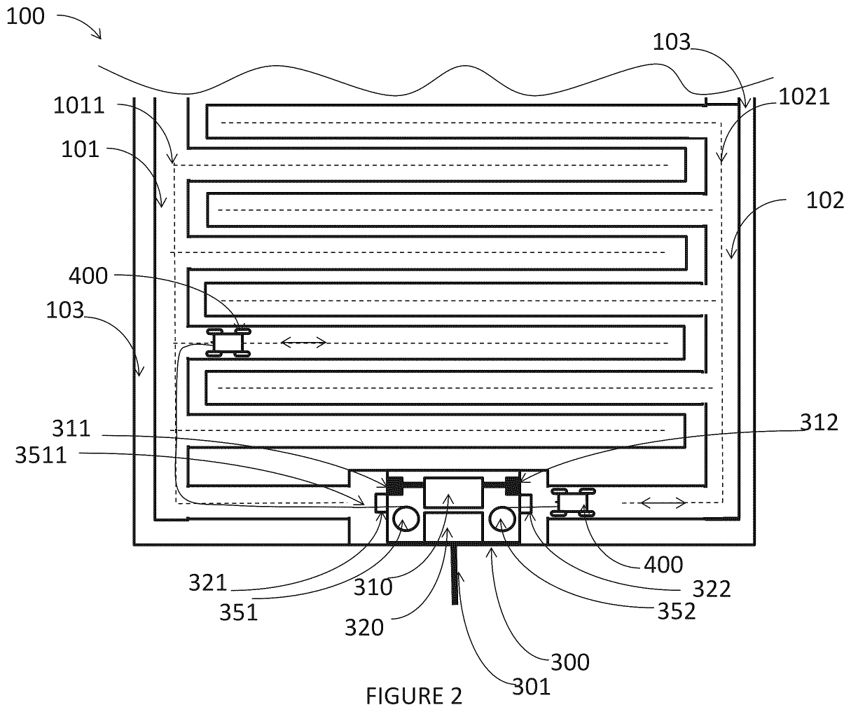

Reference is now made to the Figures, in which like numbers designate like parts. FIG. 1 is a schematic top view illustration of an embodiment of a mattress system, denoted 100, constructed and operative in accordance with the invention. Reference is now also made to FIG. 2, which is a schematic partial top view illustration of mattress 100. Mattress 100 consists of air chambers 101 and 102 with an interleaving structure supported by base sheet 103. The chambers are connected to base unit 300. Chambers 101 and 102 contain movable units 400 that comprise sensors, actuators, and operators. Base unit 300 includes air pump 310 and control unit 320 that includes a wireless communication subunit, computation subunit, and power supply subunit. Base unit 300 further includes charging mechanisms 322 and 321 for movable units 400 when they approach base unit 300. Base unit 300 further includes cable pulling mechanisms 351 and 352 for movable units 400, enabling retraction of the movable units toward base unit 300. Pulling mechanism 351 features cable 3511 which includes optional electrical wires and air pipes. Dotted lines 1011 and 1021 marked in chambers 101 and 102 respectively indicate the optional track of movable unit 400 inside each chamber.

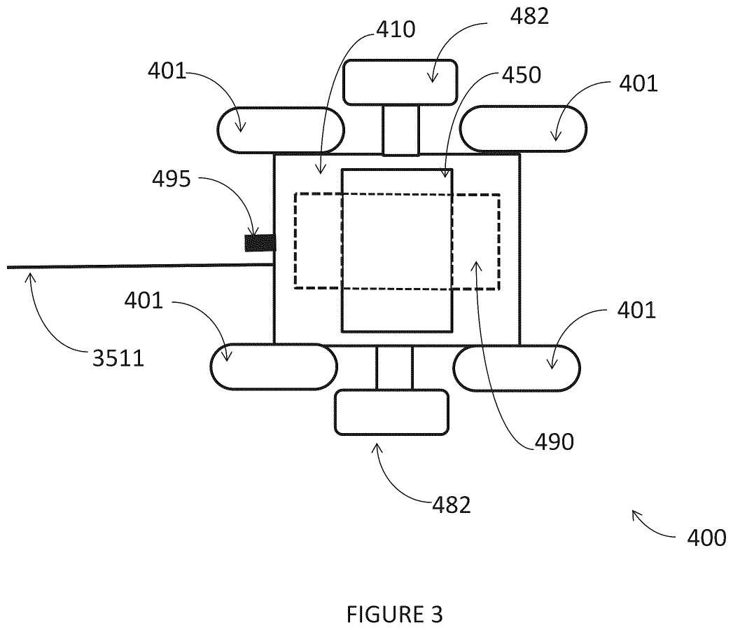

Reference is now made also to FIG. 3, which is a schematic top view illustration of a four-wheeled movable unit 400 of the embodiment of FIG. 1, featuring wheels 401. Each wheel 401 is connected to separate driving motors located inside movable unit body 400. Movable unit 400 consists of the movable unit body 410, battery 490, and actuator/sensor unit 450. A roller 482 mounted on an arm (not seen in this Figure) is used to make contact with the mattress and apply force in the direction into the human body, and also parallel to the human body, while the movable unit 400 is moving. Pulling cable 3511 is used for retraction of movable unit 400 to base unit 300, and includes power wires, communication lines, and pipes to transfer air to movable unit 400. Air is used for cooling or heating or to activate mechanical actuators (e.g., pneumatically). Battery 490 is mounted inside movable unit body 410.

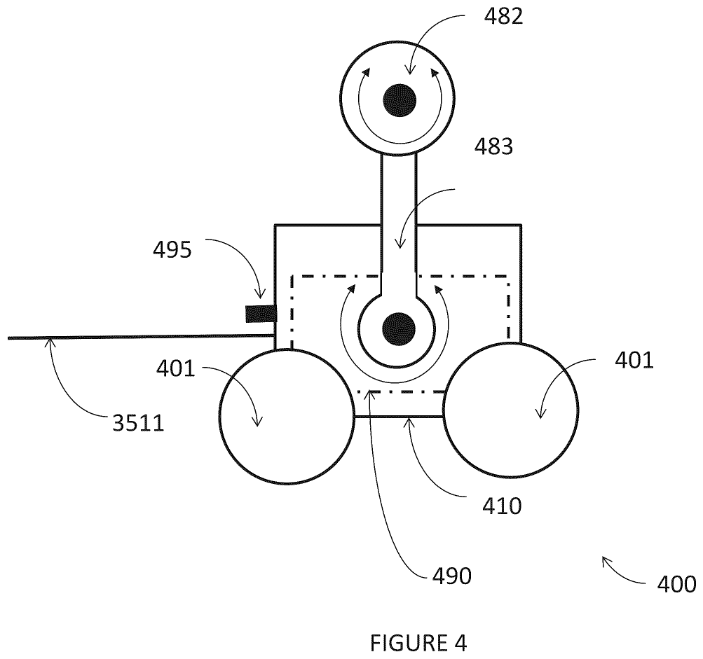

Reference is now made also to FIG. 4, which is a schematic top view illustration of four-wheeled movable unit 400. Movable unit 400 consists of movable unit body 410, battery 490, and actuator/sensor unit 450. Roller 482 is mounted on arm 483 and is used to apply force on the human body. Arm 482 and roller 483 may also help movable body 410 to rotate and/or flip over.

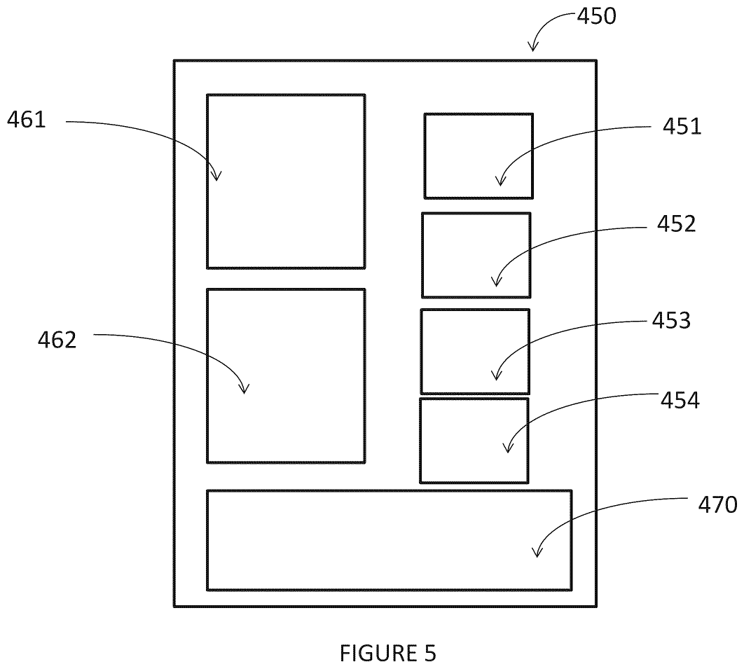

Reference is now made also to FIG. 5, which is a schematic top view illustration of optional sensors and actuators disposed in movable unit 400, represented by actuator/sensor unit 450. Actuator/sensor unit 450 comprise infrastructure, computation/electronics 470, sensors, actuators, and operators which are used to measure and treat local physical mattress and human body parameters. The sensors include temperature sensor 451, pressure sensor 452, inclination and position sensor 453, a mattress denting sensor, camera 454, a pressure wave sensor such as ultrasound array, and radar unit 462. The actuators include an active heating and cooling element 461.

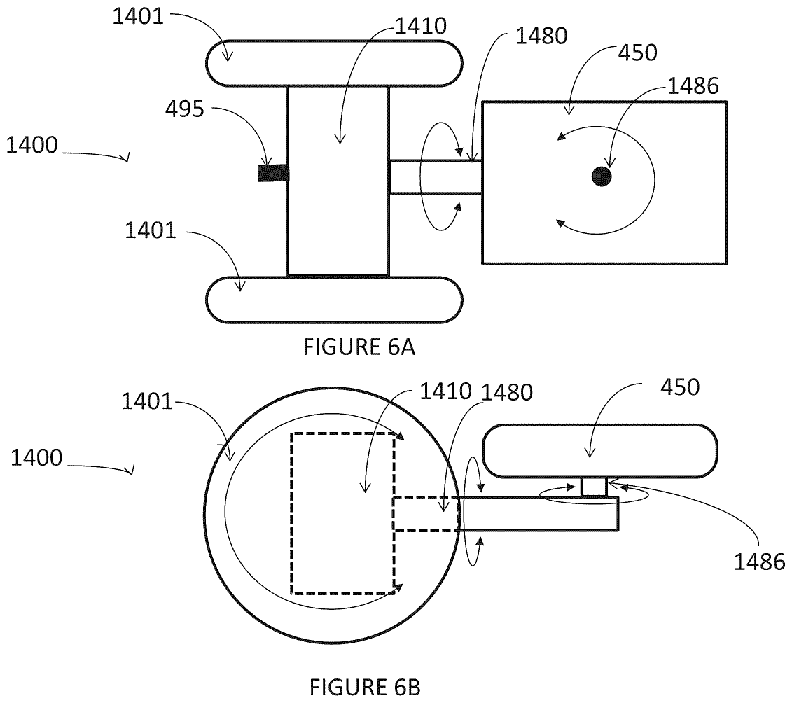

Reference is now made also to FIGS. 6A and 6B. FIG. 6A is a schematic top view illustration of an optional wireless two-wheeled movable unit 1400 featuring two motorized wheels 1401. FIG. 6B is a schematic side view illustration of movable unit 1400. Actuator/sensor unit 450 is mounted on a motorized gimbal consisting of two rotatable axes with a ±180-degree span-flip axis 1480 and side-to-side axis 1486. The gimbal enables efficient and optimal movement of sensor/actuator unit 450 toward the human body and also enables overlapping measurement actuation above nearby deflated other-chamber areas. Charging port 495 enables charging of movable unit 1400 when it approaches base unit 300 as in FIG. 2.

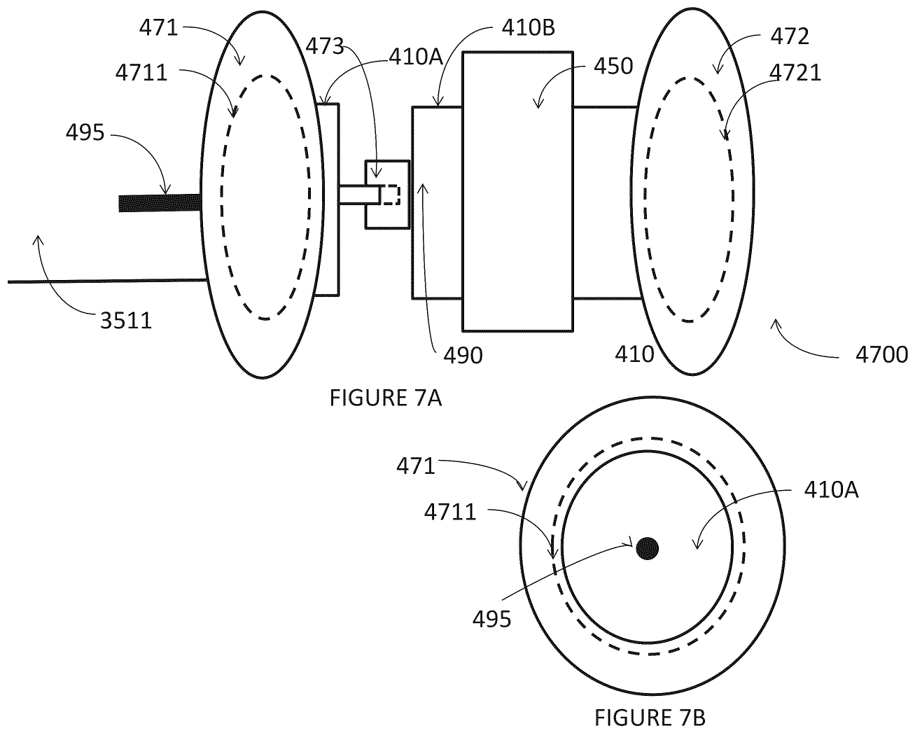

Reference is now made also to FIGS. 7A and 7B, which are schematic illustrations of optional inchworm movable unit 4700, featuring two inflation-deflation enabled torus balloons 471 and 472. FIG. 7A is a schematic top view illustration of movable unit 4700 illustrating two balloons and a piston. FIG. 7B is a schematic front view illustration of movable unit 4700. Piston 473 enables increasing and decreasing the distance between movable unit bodies 410A and 410B for advancing movable unit 4700 forward or backward in synchronization with the inflation and deflation of torus balloons 471 and 472. Dotted lines 4711 and 4721 indicate balloons 471 and 472 in a deflated state. Actuator/sensor unit 450 is mounted on movable unit 410B. Charging port 495 enables movable unit 4700 to be charged when it approaches base unit 300 as in FIG. 2.

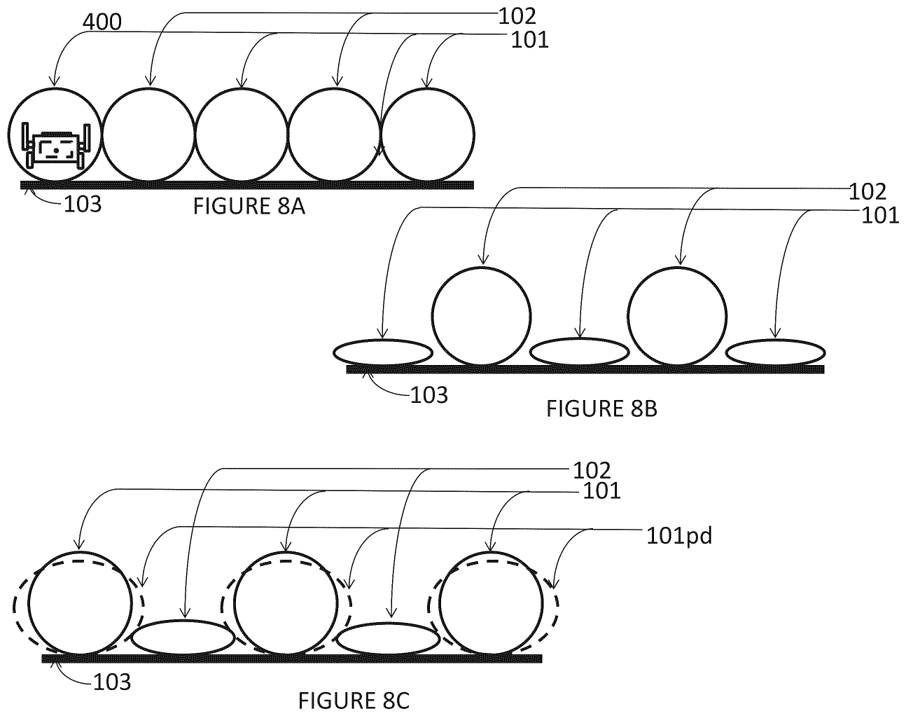

Reference is now made also to FIGS. 8A, 8B, and 8C, which are schematic illustrations of several states of the mattress chambers 101 and 102 which are mounted on base sheet 103 of a mattress. FIG. 8A is a schematic illustration of the two mattress chambers 101,102 that are inflated, wherein a movable unit is positioned in one of the chambers. FIG. 8B is a schematic illustration of mattress chambers 101, 102, wherein chamber 101 is deflated and chamber 102 is inflated. FIG. 8C is a schematic illustration of mattress chambers 101, 102, wherein chamber 102 is deflated and chamber 101 is partially deflated, to improve contact to the top of the mattress chambers and to create overlapping inspection/treating area. In FIG. 8A, both chambers are inflated with an illustration of the movable unit 400 inside chamber 101. In FIG. 8B, chamber 101 is deflated, and chamber 102 is inflated. In FIG. 8C, mattress chamber 102 is deflated and chamber 101 is partially deflated as shown by the dotted line 101pd to improve contact and create an overlapping inspection/treating area. The balloon can also be used for stabilization of the movable unit during measurement or treatment.

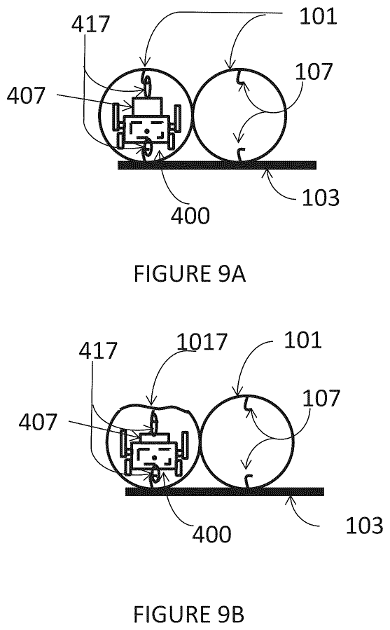

Reference is now made also to FIGS. 9A and 9B. FIG. 9A is a schematic illustration of two mattress chambers 101 that are inflated, featuring hooks 107 which are connected to the top and bottom of the mattress and which are connectable to corresponding hooks 417 of movable unit 400 to allow local vibration or movement between the mattress top and bottom area, using actuators 407 of movable unit 400. FIG. 9B is a schematic illustration of mattress chambers 101, wherein movable unit 400 is pulling together top and bottom mattress hooks 107. Mattress chambers 101 are mounted on base sheet 103, and movable unit 400 is disposed inside a chamber 101. Movable unit 400 is connected to bottom and top mattress hooks 107, using actuator 407 and its hook 417. In FIG. 9A, movable unit 400 is stationed below and above mattress hooks 107 with corresponding hooks 417. In FIG. 9B, movable unit 400 is stationed below and above mattress hooks 107 with corresponding hooks 417 and is pulling mattress hooks 107 using actuator 407, now in a compressed state, and with mattress top 1017 dented.

The mattress system described herein may be implemented with various modifications and variations without departing from the scope of the invention. In some aspects, the number and configuration of air chambers may be adjusted to accommodate different mattress sizes or patient needs. The system may be adapted for use in various settings, such as hospitals, nursing homes, or home care environments.

In some cases, the movable units may be equipped with additional or alternative sensors and actuators. For example, the system may incorporate biochemical sensors to detect markers of tissue damage or infection. The actuators may include drug delivery mechanisms for localized administration of therapeutic agents.

The control algorithms may be modified to incorporate machine learning techniques, potentially improving the system's ability to predict and prevent pressure ulcer formation over time. In certain implementations, the system may integrate with other medical devices or monitoring systems to provide a more comprehensive approach to patient care.

The wireless communication capabilities of the system may be expanded to support integration with emerging healthcare technologies, such as telemedicine platforms or electronic health record systems. In some aspects, the mattress system may be designed to operate as part of a larger network of connected healthcare devices, facilitating coordinated care and data sharing among multiple healthcare providers.

The materials used in the construction of the mattress and its components may be varied to optimize factors such as durability, comfort, and ease of cleaning. In some cases, the system may incorporate advanced materials with properties such as self-cleaning or antimicrobial characteristics.

The user interface for healthcare providers may be customized to suit different clinical workflows or specialties. In certain implementations, the system may support voice commands or gesture-based controls to facilitate hands-free operation in clinical settings.

The power management strategies for the system may be adapted to incorporate renewable energy sources or energy harvesting techniques, potentially reducing reliance on external power sources in some settings.

In some aspects, the mattress system may be designed with modular components that allow for easy upgrades or replacements of individual parts, potentially extending the useful life of the overall system and facilitating the incorporation of new technologies as they become available.

The described variations and modifications are provided as examples and should not be considered exhaustive or limiting. Those skilled in the art may conceive of additional modifications and variations that fall within the scope of the invention as described herein.

A number of implementations have been described. Nevertheless, it will be understood that various modifications may be made without departing from the spirit and scope of the disclosure. Accordingly, other implementations are within the scope of the following claims.

1. A mattress system comprising:
one or more inflatable air chambers;
one or more movable units disposed within said air chambers, said movable units equipped with sensors and actuators; and
a control unit operatively connected to said air chambers and said movable units, wherein said control unit is configured to independently inflate and deflate said air chambers to adjust pressure distribution across a surface supporting a human body, and to control movement and operation of said movable units based on data from said sensors.

2. The mattress system of claim 1, wherein said sensors include at least one of a temperature sensor, a pressure sensor, a position sensor, or a radar-based sensor.

3. The mattress system of claim 1, wherein said actuators include at least one of a heating element, a cooling element, a massaging roller, or a mechanical arm configured to manipulate localized pressure on the human body.

4. The mattress system of claim 1, wherein said movable units are configured to traverse predefined tracks within said air chambers, said tracks facilitating precise positioning of the movable units relative to the human body for localized monitoring and treatment.

5. The mattress system of claim 1, further comprising a pulling mechanism operatively connecting said movable units to a base station, said pulling mechanism comprising a cable that supplies at least one of electrical power, communication signals, or air for operation or cooling/heating of the movable units, their cooling/heating element or its vicinity.

6. The mattress system of claim 5, wherein said pulling mechanism further comprises an encoder configured to monitor the position of the movable units within the air chambers.

7. The mattress system of claim 1, wherein said air chambers are configured to operate in an overlapping manner when partially deflated, creating overlapping zones between adjacent chambers to provide enhanced monitoring and treatment coverage of the human body.

8. The mattress system of claim 1, wherein said movable units are wireless and powered by onboard rechargeable batteries, said batteries configured to recharge when the movable units are docked at a charging station.

9. The mattress system of claim 8, wherein said wireless movable units further comprise motorized wheels and a gimbal mechanism, said gimbal mechanism operable to adjust orientation of the sensors and actuators to optimize their positioning relative to the human body.

10. The mattress system of claim 1, wherein said movable units include hooks that engage corresponding hooks located in the air chambers, enabling localized pressure reduction by allowing the movable units to pull down the mattress around the engaging hooks.

11. A method of preventing and treating pressure ulcers, comprising:
providing a mattress system having one or more inflatable air chambers and one or more movable units disposed within said chambers;
continuously or intermittently inflating and deflating said air chambers to vary pressure distribution across a body;
monitoring physiological conditions of the body using sensors disposed within said movable units;
adjusting positions of said movable units based on sensor data; and
activating actuators within said movable units to provide localized treatment.

12. The method of claim 11, wherein the sensors include at least one of a temperature sensor, a pressure sensor, a position sensor, or a radar-based sensor.

13. The method of claim 11, wherein the actuators include at least one of a heating element, a cooling element, a massaging roller, or a mechanical arm configured to manipulate localized pressure on the body.

14. The method of claim 11, further comprising traversing the movable units along predefined tracks within the air chambers to facilitate precise positioning relative to the body for localized monitoring and treatment.

15. The method of claim 11, further comprising supplying at least one of electrical power, communication signals, or air for operation or cooling/heating of the movable units, their cooling/heating element or its vicinity, or a pulling mechanism operatively connecting the movable units to a base station.

16. The method of claim 15, further comprising monitoring positions of the movable units within the air chambers using an encoder associated with the pulling mechanism.

17. The method of claim 11, further comprising operating the air chambers in an overlapping manner when partially deflated to create overlapping zones between adjacent chambers, thereby providing enhanced monitoring and treatment coverage of the body.

18. The method of claim 11, further comprising wirelessly powering the movable units using onboard rechargeable batteries and recharging the batteries when the movable units are docked at a charging station.

19. The method of claim 18, further comprising adjusting orientation of the sensors and actuators using a gimbal mechanism on the movable units to optimize their positioning relative to the body.

20. A pressure ulcer prevention and treatment system comprising:
a mattress having at least two independently inflatable air chambers;
at least one movable unit disposed within each of said air chambers, each movable unit comprising sensors and actuators; and
a control unit operatively connected to said air chambers and said movable units, said control unit configured to:
control inflation and deflation of said air chambers,
direct movement of said movable units within said air chambers,
process data from said sensors, and
activate said actuators based on said processed data.
